(19) United States
(12) Patent Application Publication
(10) Pub. No.: US 2018/0026699 A1
(43) Pub. Date: Jan. 25, 2018

(54) Methods and Apparatuses for Feeding Back and Receiving Pre-coding Matrix Indicator and Communication System

(71) Applicant: FUJITSU LIMITED, Kawasaki-shi (JP)

(72) Inventors: Jian ZHANG, Beijing (CN); Xin WANG, Beijing (CN); Hua ZHOU, Beijing (CN)

(73) Assignee: FUJITSU LIMITED, Kawasaki-shi (JP)

(21) Appl. No.: 15/722,681

(22) Filed: Oct. 2, 2017

Related U.S. Application Data
(63) Continuation of application No. PCT/CN2015/076691, filed on Apr. 16, 2015.

(51) Int. Cl. H04B 7/06; H04L 27/26; H04B 7/04

(52) U.S. Cl. CPC H04B 7/0639; H04B 7/0486; H04L 27/2646; H04W 88/02

(57) ABSTRACT

Methods and apparatuses for feeding back and receiving a PMI and a communication system. The method for feeding back a PMI includes: determining an OFDM PMI of a rank r and an NOMA PMI of a rank Nr by a user equipment; and feeding back the OFDM PMI and the NOMA PMI to a base station; where, r denotes the number of ranks of the user equipment, and Nr denotes a minimum value in the number of receiving antennas of the user equipment and the number of transmitting antennas of the base station. Hence, by providing reference information to the base station for performing an NOMA scheduling, the base station is enabled to schedule appropriate user equipments, so as to ensure SIC performance. Thereby, SIC error propagation may be reduced in an MIMO system using NOMA.

### CROSS REFERENCE TO RELATED APPLICATIONS

This application is a continuation application of International Application PCT/CN2015/076691 filed on Apr. 16, 2015, the entire contents of which are incorporated herein by reference.

### TECHNICAL FIELD

This disclosure relates to the field of communication technologies, and in particular to methods and apparatuses for feeding back and receiving a non-orthogonal multiple access (NOMA) pre-coding matrix indicator (PMI) and a communication system.

### BACKGROUND

The theoretical studies of the 5th-generation (5G) mobile communication technologies have been gradually developed. One of requirements on a 5G communication system is supporting a system capacity higher than that of 4G (such as 1000 times) and a larger number of connected terminals than that of 4G (such as 100 times). All previous generations of mobile communication adopt an orthogonal multiple access technology, and it is shown by studies that a non-orthogonal multiple access technology may achieve a capacity domain larger than that of the orthogonal multiple access technology, the theoretical teaching of which makes the non-orthogonal multiple access technology become one of key technologies in the study of 5G.

One of methods for achieving non-orthogonality is non-orthogonality in a power domain, and a representative technology of that, NOMA, has been included in a discussion scope of LTE-A (Long Term Evolution-Advanced) Release 13. The NOMA technology is based on a superposed code theory, in which a transmitting device transmits superposed symbols, and a receiving device needs to use a successive interference cancel (SIC) technology to separate and recover data information. For a case where the transmitting device uses a single antenna, all capacity domains of downlink broadcast channels and uplink multiple access channels may be theoretically achieved in the NOMA technology.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that the NOMA is able to multiplex user equipments (UEs) in a power domain, the key of which is that a user equipment performing SIC is able to demodulate data of other user equipment and cancel interference of the data on its own useful signals. This requires that when the user equipment performing SIC demodulates interference signals (the interference signals are useful to other user equipment), it should have a signal to interference plus noise ratio (SINR) higher than that of any other user equipment in demodulating its own useful signals.

However, for a multiple input multiple output (MIMO) system, as different user equipments may possibly feed back different ranks, for example, a user equipment may feed back a legacy orthogonal frequency division multiplexing (OFDM) PMI of a rank=1. When two user equipments obtaining a NOMA scheduling use different ranks, the requirement that the user equipment performing SIC should have a higher SINR is hard to be satisfied, thereby resulting in a failure of first-stage demodulation of the user equipment performing SIC, and generating error propagation.

Embodiments of this disclosure provide methods and apparatuses for feeding back and receiving an NOMA PMI and a communication system, in which by feeding back auxiliary PMI information (i.e. the NOMA PMI) by a user equipment, reference information is provided to a base station for performing an NOMA scheduling, such that the base station is enabled to schedule appropriate user equipments, so as to ensure SIC performance.

According to a first aspect of the embodiments of this disclosure, there is provided a method for receiving a PMI, applicable to a base station of an NOMA system, and the method includes:

receiving an OFDM PMI of a rank r and an NOMA PMI of a rank Nr fed back by a user equipment; where, r denotes the number of ranks of the user equipment, and Nr denotes a minimum value in the number of receiving antennas of the user equipment and the number of transmitting antennas of the base station; and

performing an NOMA scheduling according to NOMA PMIs fed back by multiple user equipments.

According to a second aspect of the embodiments of this disclosure, there is provided an apparatus for receiving a PMI, configured in a base station of an NOMA system, and the apparatus includes:

an indicator receiving unit configured to receive an orthogonal frequency division multiplexing (OFDM) PMI of a rank r and an NOMA PMI of a rank Nr fed back by a user equipment; where, r denotes the number of ranks of the user equipment, and Nr denotes a minimum value in the number of receiving antennas of the user equipment and the number of transmitting antennas of the base station; and

a scheduling unit configured to perform an NOMA scheduling according to NOMA PMIs fed back by multiple user equipments.

According to a third aspect of the embodiments of this disclosure, there is provided a method for feeding back a PMI, applicable to a user equipment of an NOMA system, and the method includes:

determining an OFDM PMI of a rank r and an NOMA PMI of a rank Nr; where, r denotes the number of ranks of the user equipment, and Nr denotes a minimum value in the number of receiving antennas of the user equipment and the number of transmitting antennas of a base station; and

feeding back the OFDM PMI and the NOMA PMI to the base station.

According to a fourth aspect of the embodiments of this disclosure, there is provided an apparatus for feeding back a PMI, configured in a user equipment of an NOMA system, and the apparatus includes:

an indicator determining unit configured to determine an OFDM PMI of a rank r and an NOMA PMI of a rank Nr; where, r denotes the number of ranks of the user equipment, and Nr denotes a minimum value in the number of receiving antennas of the user equipment and the number of transmitting antennas of a base station; and

an indicator feedback unit configured to feed back the OFDM PMI and the NOMA PMI to the base station.

According to a fifth aspect of the embodiments of this disclosure, there is provided a communication system using NOMA, and the communication system includes:

a user equipment configured to determine and feed back an OFDM PMI of a rank r and an NOMA PMI of a rank Nr; where, r denotes the number of ranks of the user equipment, and Nr denotes a minimum value in the number of receiving antennas of the user equipment and the number of transmitting antennas of a base station; and

the base station configured to receive the OFDM PMI and the NOMA PMI fed back by the user equipment, and perform an NOMA scheduling according to NOMA PMIs fed back by multiple user equipments.

According to another aspect of the embodiments of this disclosure, there is provided a computer readable program code, which, when executed in a base station, will cause a computer unit to carry out the method for receiving a PMI as described above in the base station.

According to a further aspect of the embodiments of this disclosure, there is provided a computer readable medium, including a computer readable program code, which will cause a computer unit to carry out the method for receiving a PMI as described above in a base station.

According to still another aspect of the embodiments of this disclosure, there is provided a computer readable program code, which, when executed in a UE, will cause a computer unit to carry out the method for feeding back a PMI as described above in the UE.

According to yet another aspect of the embodiments of this disclosure, there is provided a computer readable medium, including a computer readable program code, which will cause a computer unit to carry out the method for feeding back a PMI as described above in a UE.

An advantage of the embodiments of this disclosure exists in that by feeding back an OFDM PMI of a rank r and an NOMA PMI of a rank Nr by the user equipment, reference information is provided to the base station for performing an NOMA scheduling, such that the base station is enabled to schedule appropriate user equipments, so as to ensure SIC performance. Thereby, SIC error propagation may be reduced in an MIMO system using NOMA.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of an MIMO system of an embodiment of this disclosure;

FIG. 2 is a flowchart of the method for receiving a PMI of Embodiment 1 of this disclosure;

FIG. 3 is a flowchart of the method for feeding back a PMI of Embodiment 2 of this disclosure;

FIG. 4 is a schematic diagram of the apparatus for receiving a PMI of Embodiment 3 of this disclosure;

FIG. 5 is a schematic diagram of the base station of Embodiment 3 of this disclosure;

FIG. 6 is a schematic diagram of the apparatus for feeding back a PMI of Embodiment 4 of this disclosure;

FIG. 7 is a schematic diagram of the user equipment of Embodiment 4 of this disclosure; and

FIG. 8 is a schematic diagram of the communication system of Embodiment 5 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In an MIMO system, it is assumed that a base station and a user equipment are both configured with two antennas. A channel experienced by UE 1 is denoted by H₁, its noise is denoted by n₁, and a pathloss is denoted by p₁; and a channel experienced by UE 2 is denoted by H₂, its noise is denoted by n₂, and a pathloss is denoted by p₂.

Assuming that ρ₁<ρ₂, a signal to noise ratio of UE 1 is higher than that of UE 2, thus UE 1 is capable of supporting dual-stream transmission of a rank of 2, and as a signal to noise ratio of UE 2 is relatively low, it is capable of supporting single-stream transmission of a rank of 1. In this case, the base station may transmit symbols a₁, a₂ to UE 1 in an NOMA manner, and used pre-coding vectors may be denoted by w₁, w₂; and the base station may transmit a symbol b₁ to UE 2, and a used pre-coding vector may be denoted by w₁.

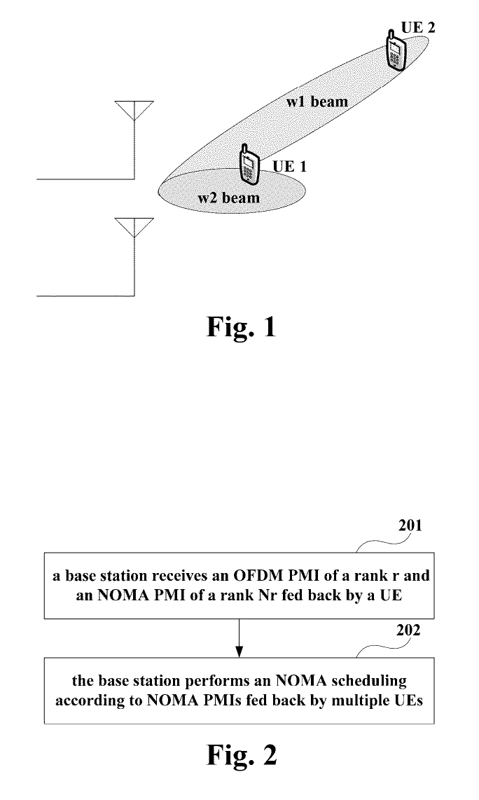

FIG. 1 is a schematic diagram of an MIMO system of an embodiment of this disclosure, in which two UEs performing an NOMA scheduling are shown. As shown in FIG. 1, UE 1 and UE 2 perform NOMA multiplexing in the power domain only in a beam w₁.

It is assumed that total power of the base station is P, the base station allocates different power for different symbols, and uses identical time frequency resources to transmit a superposed symbol in the power domain. And it is further assumed that power allocated for symbols a₁, a₂, b₁ is 0.5P₁, 0.5P₁, P₂, respectively; where, P₁+P₂=P; the NOMA superposed symbol transmitted by the base station is w₁\sqrt{0.5P₁}a₁+w₁\sqrt{P₂}b₁+w₂\sqrt{0.5P₁}a₂, and symbols received by UE 1 and UE 2 are respectively expressed as follows:

y₁=\sqrt{ρ₁}H₁(w₁\sqrt{0.5P₁}a₁+w₁\sqrt{P₂}b₁+w₂\sqrt{0.5P₁}a₂)+n₁,

y₂=\sqrt{ρ₂}H₂(w₁\sqrt{0.5P₁}a₁+w₁\sqrt{P₂}b₁+w₂\sqrt{0.5P₁}a₂)+n₂.

After receiving the signal transmitted by the base station, UE 2 demodulates symbol b₁ of its own, and for the sake of SIC, UE 1 needs also to demodulate b₁, and demodulate symbols a₁,a₂ of its own after cancelling interference of b₁. A SINR of UE 1 for demodulating symbol b₁ of UE 2 is denoted by SINR_{1d2}, and a SINR of UE 2 for demodulating symbol b₁ of its own is denoted by SINR_{2d2}, and noise power is denoted by σ², then,

SINR_{1d2}=P₂w₁^{H}H₁^{H}(H₁(0.5P₁w₁w₁^{H}+0.5P₁w₂w₂^{H})H₁^{H}+σ²/ρ₁I)⁻¹H₁w₁ (1),

SINR_{2d2}=P₂w₁^{H}H₂^{H}(H₂(0.5P₁w₁w₁^{H}+0.5P₁w₂w₂^{H})H₂^{H}+σ²/ρ₂I)⁻¹H₂w₁ (2).

SINR_{1d2}>SINR_{2d2} needs to be satisfied when symbol b₁ of UE 2 is successfully demodulated by UE 1. However, the above expressions of SINR_{1d2}, SINR_{2d2} cannot always ensure that SINR_{1d2}>SINR_{2d2}, and an error of demodulation of k will result in error propagation, and will directly affect subsequent demodulation of a₁, a₂ by UE 1.

How to solve the above problem shall be described below in detail in the embodiments of this disclosure.

### Embodiment 1

The embodiment of this disclosure provides a method for receiving a PMI, applicable to a base station of an NOMA system.

FIG. 2 is a flowchart of the method for receiving a PMI of the embodiment of this disclosure. As shown in FIG. 2, the method for receiving a PMI includes:

block 201: a base station receives an OFDM PMI of a rank r and an NOMA PMI of a rank Nr fed back by a UE; where, r denotes the number of ranks of the UE, and Nr denotes a minimum value in the number of receiving antennas of the UE and the number of transmitting antennas of the base station; and

block 202: the base station performs an NOMA scheduling according to NOMA PMIs fed back by multiple UEs.

In this embodiment, for the above-described formulae (1) and (2), it was found that when H₁=e^{jθ}H₂, that is, when H₁, H₂ have identical directions, SINR_{1d2}>SINR_{2d2} may be ensured. Thus, when the UE performs PMI feedback, the UE may be made to feed back a PMI (which may also be referred to as an NOMA PMI) quantizing an integral channel matrix of its own.

In this embodiment, the PMI fed back by the UE may include an OFDM PMI of a rank r (i.e. a legacy PMI) and an NOMA PMI of a rank Nr; where, r denotes the number of ranks of the UE, and Nr denotes a minimum value in the number of receiving antennas of the UE and the number of transmitting antennas of the base station. After the UE feeds back such auxiliary information, it is helpful to satisfy SINR_{1d2}>SINR_{2d2}, thereby reducing error propagation.

For example, for the above UE 2, as it uses rank 1 to perform single-stream transmission, only a PMI (a legacy OFDM PMI) of a rank of 1 (rank-1) will be fed back according to an existing standard; however, this PMI is insufficient to depict an integral channel matrix direction of UE 2.

In order to ensure the SIC performance of the NOMA, the embodiment of this disclosure may make UE 2 also feed back a PMI (which may also be referred to as an NOMA PMI) of a rank of 2 (rank-2; as described above, the base station and the UE are configured with two antennas, that is, the number of receiving antennas of the UE and the number of transmitting antennas of the base station are both 2, hence, Nr is also 2 at this moment), so as to characterize the integral channel matrix direction of UE 2. After receiving the NOMA PMI characterizing information on the integral channel matrix fed back by the UE, the base station will perform a corresponding NOMA scheduling according to the NOMA PMI, that is, the base station may select UEs to perform NOMA pairing transmission from two or more UEs feeding back identical NOMA PMIs.

For example, in performing NOMA pairing of UEs, the base station may select two UEs feeding back identical NOMA PMIs to perform an NOMA scheduling, thereby ensuring that SINR_{1d2}>SINR_{2d2} is satisfied for the UEs, and better ensuring the SIC performance of the NOMA.

In this embodiment, when the UE determines the NOMA PMI, a selecting criterion may be based on a distance criterion, such that a direction of the PMI of rank-2 and a direction of a channel H₂ are closest to each other. For example, a chodal distance is used, and a W that minimizes Tr(W^{H},H₂)/∥W∥∥H₂∥ may be selected from a codebook, and an index of the W may be taken as the NOMA PMI feedback; where, Tr is a trace of the matrix, and ∥ denotes a normal. And the relevant art may be referred to for parameters and meanings in the above formula.

In this embodiment, a pre-coding matrix identified by the NOMA PMI may have the numbers of rows and columns identical to that of the channel matrix H₂, that is, the number of rows of the pre-coding matrix identified by the NOMA PMI is the number of transmitting antennas of the UE, and the number of columns thereof is the number of receiving antennas of the UE. Hence, the NOMA PMI may depict the integral channel matrix direction of the UE.

It can be seen from the above embodiment that by feeding back an OFDM PMI of a rank r and an NOMA PMI of a rank Nr by the UE, reference information is provided to the base station for performing an NOMA scheduling, such that the base station is enabled to schedule appropriate UEs, so as to ensure SIC performance. Thereby, SIC error propagation may be reduced in an MIMO system using NOMA.

### Embodiment 2

The embodiment of this disclosure provides a method for feeding back a PMI, applicable to a UE of an NOMA system, with contents identical to those in Embodiment 1 being not going to be described herein any further.

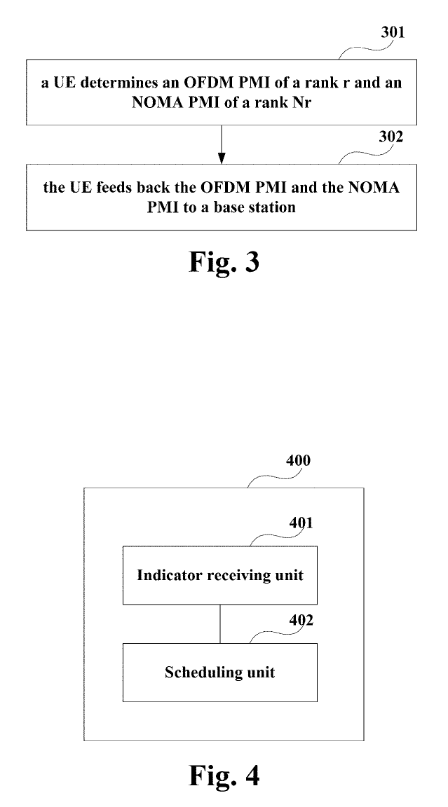

FIG. 3 is a flowchart of the method for feeding back a PMI of the embodiment of this disclosure. As shown in FIG. 3, the method for feeding back a PMI includes:

block 301: the UE determines an OFDM PMI of a rank r and an NOMA PMI of a rank Nr; where, r denotes the number of ranks of the user equipment, and Nr denotes a minimum value in the number of receiving antennas of the user equipment and the number of transmitting antennas of a base station; and

block 302: the UE feeds back the OFDM PMI and the NOMA PMI to the base station.

In this embodiment, the NOMA PMI is used to quantize an integral channel matrix of the UE itself.

In this embodiment, the UE may make a direction of the PMI of a rank Nr and a direction of a channel H2 of the UE be closest to each other based on a distance criterion. However, this disclosure is not limited thereto, and other methods may also be used to determine the PMI of a rank Nr.

In this embodiment, the following method may particularly be used: selecting a W from a codebook that makes Tr(W^{H},H₂)/∥W∥∥H₂∥ minimal, and taking an index of the W as the NOMA PMI; wherein, the number of rows of a pre-coding matrix identified by the NOMA PMI is the number of transmitting antennas of the UE, and the number of columns thereof is the number of receiving antennas of the UE.

It can be seen from the above embodiment that by feeding back an OFDM PMI of a rank r and an NOMA PMI of a rank Nr by the UE, reference information is provided to the base station for performing an NOMA scheduling, such that the base station is enabled to schedule appropriate UEs, so as to ensure SIC performance. Thereby, SIC error propagation may be reduced in an MIMO system using NOMA.

### Embodiment 3

The embodiment of this disclosure provides an apparatus for receiving a PMI, configured in a base station of an NOMA system. The embodiment of this disclosure corresponds to the method for receiving a PMI in Embodiment 1, with identical contents being not going to be described herein any further.

FIG. 4 is a schematic diagram of the apparatus for receiving a PMI of the embodiment of this disclosure. As shown in FIG. 4, the apparatus 400 for receiving a PMI includes:

an indicator receiving unit 401 configured to receive an OFDM PMI of a rank r and an NOMA PMI of a rank Nr fed back by a UE; where, r denotes the number of ranks of the UE, and Nr denotes a minimum value in the number of receiving antennas of the UE and the number of transmitting antennas of the base station; and

a scheduling unit 402 configured to perform an NOMA scheduling according to NOMA PMIs fed back by multiple UEs.

In this embodiment, the NOMA PMI is used to quantize an integral channel matrix of the UE itself.

In this embodiment, the scheduling unit 402 may particularly be configured to select UEs for performing NOMA pairing transmission from two or more user equipments feeding back identical NOMA PMIs.

The embodiment of this disclosure further provides a base station, configured with the above apparatus 400 for receiving a PMI.

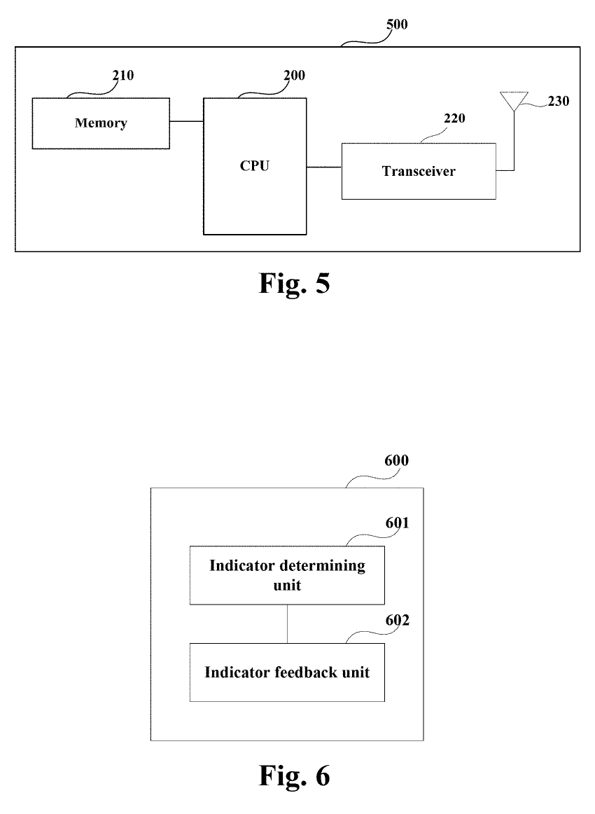

FIG. 5 is a schematic diagram of the base station of the embodiment of this disclosure. As shown in FIG. 5, the base station 500 may include a central processing unit (CPU) 200 and a memory 210, the memory 210 being coupled to the central processing unit 200. The memory 210 may store various data, and furthermore, it may store a program for information processing, and execute the program under control of the central processing unit 200.

For example, the base station 500 may carry out the method for receiving a PMI described in Embodiment 1. And the central processing unit 200 may be configured to carry out the functions of the apparatus 400 for receiving a PMI, that is, the central processing unit 200 may be configured to perform the following control: receiving an OFDM PMI of a rank r and an NOMA PMI of a rank Nr fed back by a user equipment; and performing an NOMA scheduling according to NOMA PMIs fed back by multiple user equipments; where, r denotes the number of ranks of the user equipment, and Nr denotes a minimum value in the number of receiving antennas of the user equipment and the number of transmitting antennas of the base station.

Furthermore, as shown in FIG. 5, the base station 500 may include a transceiver 220, and an antenna 230, etc. Functions of the above components are similar to those in the relevant art, and shall not be described herein any further. It should be noted that the base station 500 does not necessarily include all the parts shown in FIG. 5, and furthermore, the base station 500 may include parts not shown in FIG. 5, and the relevant art may be referred to.

It can be seen from the above embodiment that by feeding back an OFDM PMI of a rank r and an NOMA PMI of a rank Nr by the UE, reference information is provided to the base station for performing an NOMA scheduling, such that the base station is enabled to schedule appropriate UEs, so as to ensure SIC performance. Thereby, SIC error propagation may be reduced in an MIMO system using NOMA.

### Embodiment 4

The embodiment of this disclosure provides an apparatus for feeding back a PMI, configured in a UE of an NOMA system. The embodiment of this disclosure corresponds to the method for feeding back a PMI in Embodiment 2, with identical contents being not going to be described herein any further.

FIG. 6 is a schematic diagram of the apparatus for feeding back a PMI of the embodiment of this disclosure. As shown in FIG. 6, the apparatus 600 for feeding back a PMI includes:

an indicator determining unit 601 configured to determine an OFDM PMI of a rank r and an NOMA PMI of a rank Nr; where, r denotes the number of ranks of the user equipment, and Nr denotes a minimum value in the number of receiving antennas of the user equipment and the number of transmitting antennas of a base station; and

an indicator feedback unit 602 configured to feed back the OFDM PMI and the NOMA PMI to the base station.

In this embodiment, the NOMA PMI is used to quantize an integral channel matrix of the user equipment itself.

In this embodiment, the indicator determining unit 601 may be configured to make a direction of the PMI of a rank Nr and a direction of a channel H2 of the UE be closest to each other based on a distance criterion.

For example, the indicator determining unit 601 is configured to select a W from a codebook that makes Tr(W^{H},H₂)/∥W∥∥H₂∥ minimal, and take an index of the W as the NOMA PMI; and the number of rows of a pre-coding matrix identified by the NOMA PMI is the number of transmitting antennas of the user equipment, and the number of columns thereof is the number of receiving antennas of the user equipment.

The embodiment of this disclosure further provides a UE, configured with the above apparatus 600 for feeding back a PMI.

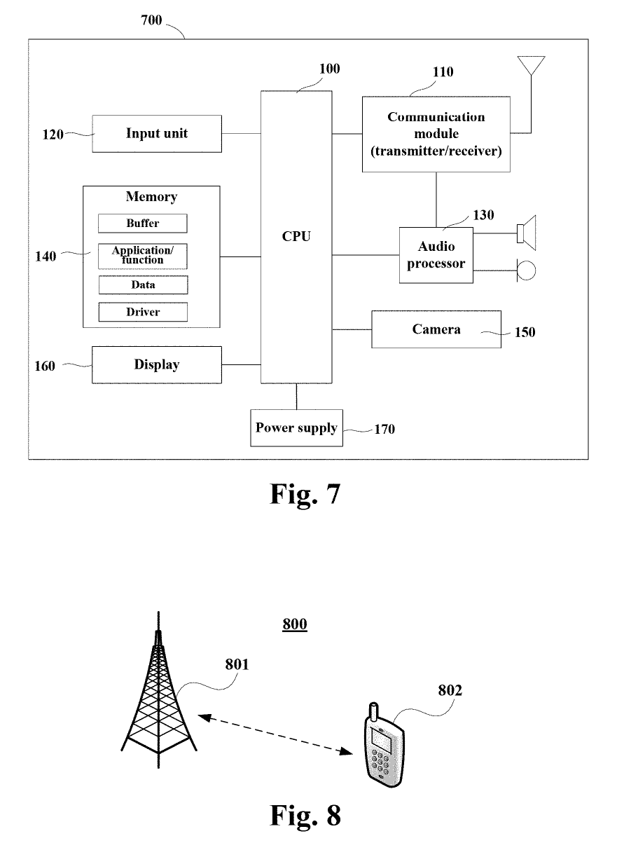

FIG. 7 is a schematic diagram of the UE of the embodiment of this disclosure. As shown in FIG. 7, the UE 700 may include a central processing unit 100 and a memory 140, the memory 140 being coupled to the central processing unit 100. It should be noted that this figure is illustrative only, and other types of structures may also be used, so as to supplement or replace this structure and achieve a telecommunications function or other functions.

In an implementation, the functions of the apparatus 600 for feeding back a PMI may be integrated into the central processing unit 100. For example, the central processing unit 100 may be configured to perform following control: determining and feeding back an OFDM PMI of a rank r and an NOMA PMI of a rank Nr; where, r denotes the number of ranks of the user equipment, and Nr denotes a minimum value in the number of receiving antennas of the user equipment and the number of transmitting antennas of a base station.

In another implementation, the apparatus 600 for feeding back a PMI and the central processing unit 100 may be configured separately. For example, the apparatus 600 for feeding back a PMI may be configured as a chip connected to the central processing unit 100, with its functions being realized under control of the central processing unit 100.

As shown in FIG. 7, the UE 700 may further include a communication module 110, an input unit 120, an audio processor 130, a memory 140, a camera 150, a display 160 and a power supply 170. Functions of the above components are similar to those in the relevant art, and shall not be described herein any further. It should be noted that the UE 700 does not necessarily include all the parts shown in FIG. 7, and furthermore, the UE 700 may include parts not shown in FIG. 7, and the relevant art may be referred to.

It can be seen from the above embodiment that by feeding back an OFDM PMI of a rank r and an NOMA PMI of a rank Nr by the UE, reference information is provided to the base station for performing an NOMA scheduling, such that the base station is enabled to schedule appropriate UEs, so as to ensure SIC performance. Thereby, SIC error propagation may be reduced in an MIMO system using NOMA.

### Embodiment 5

The embodiment of this disclosure provides a communication system using NOMA, with contents identical to those in embodiments 1-4 being not going to be described herein any further. FIG. 8 is a schematic diagram of the communication system of the embodiment of this disclosure. As shown in FIG. 8, the communication system 800 includes a base station 801 and a UE 802.

The UE 802 may be configured to determine and feed back an OFDM PMI of a rank r and an NOMA PMI of a rank Nr; where, r denotes the number of ranks of the user equipment, and Nr denotes a minimum value in the number of receiving antennas of the user equipment and the number of transmitting antennas of the base station.

And the base station 801 may be configured to receive the OFDM PMI and the NOMA PMI fed back by the UE 802, and perform an NOMA scheduling according to NOMA PMIs fed back by multiple UEs.

In this embodiment, the NOMA PMI is used to quantize an integral channel matrix of the user equipment itself.

An embodiment of the present disclosure provides a computer readable program code, which, when executed in a base station, will cause a computer unit to carry out the method for receiving a PMI described in Embodiment 1 in the base station.

An embodiment of the present disclosure provides a computer readable medium, including a computer readable program code, which will cause a computer unit to carry out the method for receiving a PMI described in Embodiment 1 in a base station.

An embodiment of the present disclosure provides a computer readable program code, which, when executed in a UE, will cause a computer unit to carry out the method for feeding back a PMI described in Embodiment 2 in the UE.

An embodiment of the present disclosure provides a computer readable medium, including a computer readable program code, which will cause a computer unit to carry out the method for feeding back a PMI described in Embodiment 2 in a UE.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for receiving a pre-coding matrix indicator (PMI), configured in a base station of a non-orthogonal multiple access (NOMA) system, the apparatus for receiving a PMI comprising:
an indicator receiving unit configured to receive an orthogonal frequency division multiplexing (OFDM) PMI of a rank r and an NOMA PMI of a rank Nr fed back by a user equipment; where, r denotes the number of ranks of the user equipment, and Nr denotes a minimum value in the number of receiving antennas of the user equipment and the number of transmitting antennas of the base station; and
a scheduling unit configured to perform an NOMA scheduling according to NOMA PMIs fed back by multiple user equipments.

2. The apparatus for receiving a PMI according to claim 1, wherein the scheduling unit is configured to select user equipments for performing NOMA pairing transmission from two or more user equipments feeding back identical NOMA PMIs.

3. The apparatus for receiving a PMI according to claim 1, wherein the NOMA PMI is used to quantize an integral channel matrix of the user equipment itself.

4. An apparatus for feeding back a pre-coding matrix indicator (PMI), configured in a user equipment of a non-orthogonal multiple access (NOMA) system, the apparatus for feeding back comprising:
an indicator determining unit configured to determine an OFDM PMI of a rank r and an NOMA PMI of a rank Nr; where, r denotes the number of ranks of the user equipment, and Nr denotes a minimum value in the number of receiving antennas of the user equipment and the number of transmitting antennas of a base station; and
an indicator feedback unit configured to feed back the OFDM PMI and the NOMA PMI to the base station.

5. The apparatus for feeding back a PMI according to claim 4, wherein the NOMA PMI is used to quantize an integral channel matrix of the user equipment itself.

6. The apparatus for feeding back a PMI according to claim 4, wherein the indicator determining unit is configured to make a direction of the PMI of a rank Nr and a direction of a channel H2 of the user equipment be closest to each other based on a distance criterion.

7. The apparatus for feeding back a PMI according to claim 6, wherein the indicator determining unit is configured to select a W from a codebook that makes Tr(W^{H},H₂)/∥W∥∥H₂∥ minimal, and take an index of the Was the NOMA PMI;
wherein, the number of rows of a pre-coding matrix identified by the NOMA PMI is the number of transmitting antennas of the user equipment, and the number of columns thereof is the number of receiving antennas of the user equipment.

8. A communication system using non-orthogonal multiple access (NOMA), the communication system comprising:
a user equipment configured to determine and feed back an OFDM PMI of a rank r and an NOMA PMI of a rank Nr; where, r denotes the number of ranks of the user equipment, and Nr denotes a minimum value in the number of receiving antennas of the user equipment and the number of transmitting antennas of a base station; and
the base station configured to receive the OFDM PMI and the NOMA PMI fed back by the user equipment, and perform an NOMA scheduling according to NOMA PMIs fed back by multiple user equipments.

9. The communication system according to claim 8, wherein the NOMA PMI is used to quantize an integral channel matrix of the user equipment itself.
